(19) United States
(12) Patent Application Publication
(10) Pub. No.: US 2015/0056911 A1
(43) Pub. Date: Feb. 26, 2015

(54) SYSTEM FOR DAMPER ACTIVATION NOTIFICATION

(71) Applicant: General Electric Company, Schenectady, NY (US)

(72) Inventors: Sherry Payne Brockman, Louisville, KY (US); Vern A. Neal, Louisville, KY (US); Erin Rae Kirkpatrick, Louisville, KY (US)

(73) Assignee: General Electric Company, Schenectady, NY (US)

(21) Appl. No.: 13/971,978

(22) Filed: Aug. 21, 2013

(51) Int. Cl. F24F 11/00; G08B 5/22; G08B 3/10

(52) U.S. Cl. CPC F24F 11/0001; F24F 11/001; F24F 11/0076; G08B 3/10; G08B 5/22; F24F 2011/0002; F24F 2011/0038; F24F 2011/0056
USPC 454/256; 126/299 D; 340/606

(57) ABSTRACT

A system is provided for determining whether a damper controlling the flow of make-up air into a kitchen is properly functioning when the kitchen ventilation system is operating. When the kitchen ventilation system is activated, a notification can be provided to a user of the kitchen whereby the user will know whether the damper is open such that make-up air is available for replacing air drawn out of the kitchen by the ventilation system. The notification device can be conveniently positioned in the kitchen so that the user can readily check for proper damper operation when the ventilation system is operating.

### FIELD OF THE INVENTION

The subject matter of the present disclosure relates generally to a system that provides notification of whether a damper for providing air ventilation is operating properly.

### BACKGROUND OF THE INVENTION

Contemporary kitchens are commonly provided with a ventilation system for removing heat and/or cooking fumes created by cooking operations. Typically, an air intake is provided near e.g., a cooktop, stovetop, or other cooking appliance. The air intake may be located e.g., in a hood positioned over the appliance or another ventilation unit positioned near the appliance. The air intake can be connected with a duct that leads to an exterior wall or roof for venting outside—i.e. to ambient. One or more fans can be used to provide suction that pulls an air flow through the kitchen, over the cooking appliance(s), and into the duct for delivery to ambient. Controls are commonly provided for activating the fan and may include features for controlling speed and, therefore, the amount of air flow.

Depending upon e.g., the size of the fan, its operating speed, and other factors, the volume of air that is pulled into the intake and exhausted outside can be substantial. To facilitate proper operation, makeup air in the form of air fed into the kitchen from the outside may be necessary so that proper air flow through the kitchen is created during operation of the fan. Building codes and/or other applicable regulations may even require that make-up air is provided in certain circumstances. For example, the International Residential Code (2012) requires a make-up air system if a kitchen hood ventilation unit is capable of exhausting 400 cubic feet per minute or more of air from the kitchen.

Make-up air can be provided by a make-up air system that allows air to be drawn into the building containing the kitchen. A duct can be connected with an opening that serves as an inlet for air from the ambient. The duct may be e.g., connected into the air-conditioning (cooling, heating, or both) system for the kitchen and/or building. When the kitchen ventilation system is activated to draw air out of the kitchen, make-up air from outside is also drawn into the kitchen through the make-up air system.

The egress or ingress of air through the make-up air system can be controlled by a damper placed into the duct downstream of the inlet connected to ambient. The damper acts as a valve to control air flow. When air flow through the duct is desired, the damper is opened. In order to stop the flow of air from the outside (or the loss of conditioned air to the outside), the damper is closed.

As indicated, proper operation of the kitchen ventilation system can depend upon the damper opening properly when the kitchen ventilation system is activated. Unfortunately, for a variety of reasons, the damper can malfunction by not opening when the kitchen ventilation system is activated. For example, the opening mechanism on the damper may be broken, stuck, or blocked. Other problems can also prevent proper operation.

Unfortunately, the damper controlling the flow of make-up air from ambient is typically located in a non-frequented area such as a basement, crawl space, attic, etc. Such area may also not be readily accessible and/or not viewable from the kitchen. As such, if the damper is malfunctioning by not opening when the kitchen ventilation system is activated, the user may be unaware. The user may continue to use the kitchen without knowledge that air flow needed for proper kitchen ventilation is not being provided. Alternatively, the user may realize the proper air flow is not occurring, but may assume a problem is occurring with the kitchen ventilation system rather than the damper.

Accordingly, a system that can provide notification regarding whether a damper for make-up air is properly functioning would be useful. Such a system that can provide notification to the user while present in the kitchen would also be beneficial.

### BRIEF DESCRIPTION OF THE INVENTION

The present invention provides a system for determining whether a damper controlling the flow of make-up air into kitchen is properly functioning when the kitchen ventilation system is operating. When the kitchen ventilation system is activated, a notification can be provided to a user of the kitchen whereby the user will know whether the damper is open such that make-up air is available for replacing air drawn out of the kitchen by the ventilation system. The notification device can be conveniently positioned in the kitchen so that the user can readily check for proper damper operation when the ventilation system is operating. Additional aspects and advantages of the invention will be set forth in part in the following description, or may be apparent from the description, or may be learned through practice of the invention.

In one exemplary embodiment, the present invention provides a system for providing notification of damper activation that includes a ventilation system for providing an air exhaust from a kitchen to a location exterior of the kitchen, the ventilation system having an air inlet for the receipt of air from the kitchen. Also included is a make-up air system configured for providing air into the kitchen from ambient. The make-up air system includes an ambient air inlet for the flow of air into the make-up air system from the ambient; a damper positioned downstream of the ambient air inlet, the damper configured for movement between an open position where air can flow into the make-up air system from the ambient and a closed position where air from the ambient is blocked from flowing through the make-up air system; and a damper sensor configured for detecting whether the damper is in an open position. A notification device is provided for viewing by a user. The notification device is configured for providing a notification to the user based on the damper sensor detecting the damper changing between the closed position and the open position.

In another exemplary aspect, the present invention provides a method of providing notification of damper operation with a kitchen ventilation system and a make-up air system. The make-up air system includes a damper for controlling a flow of air from ambient into the kitchen. The damper has an open position for allowing the flow of air from ambient and a closed position for blocking the flow of air from ambient. The method includes the steps of operating the kitchen ventilation system so as to move air through the kitchen to remove heat, cooking fumes, or both; detecting whether the damper is in the open position; and providing a notification for a user of the kitchen regarding whether the damper is in the open position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of an exemplary range hood and cooking appliance as may be used in exemplary embodiments of the present invention.

FIG. 2 is a schematic view of an exemplary embodiment of the present invention.

FIG. 3 is an exemplary notification device of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

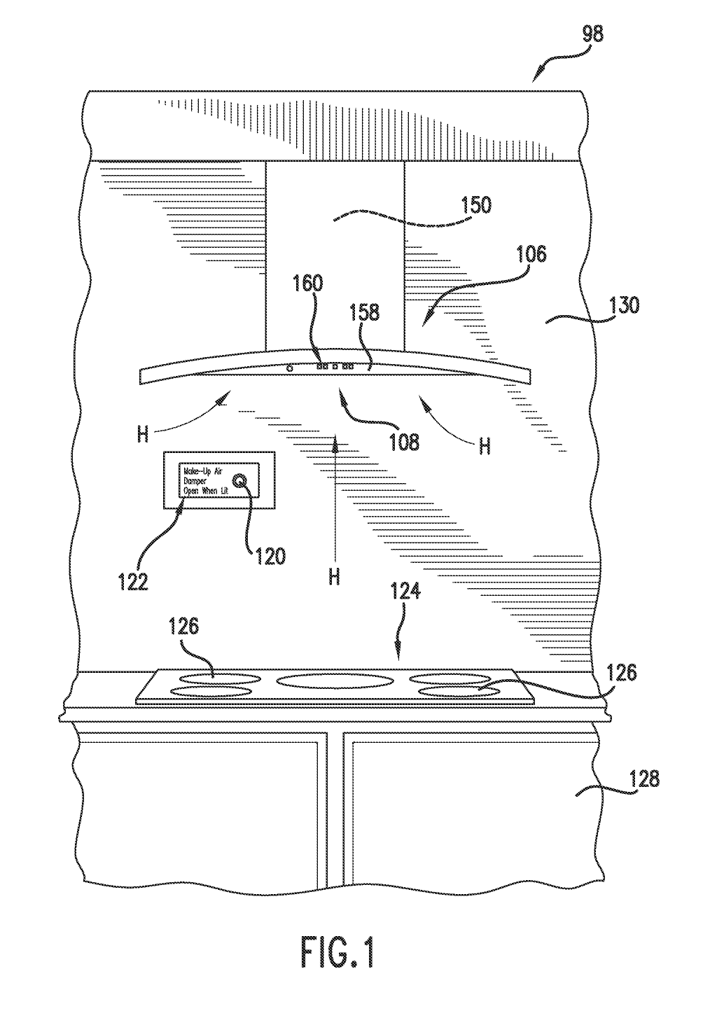

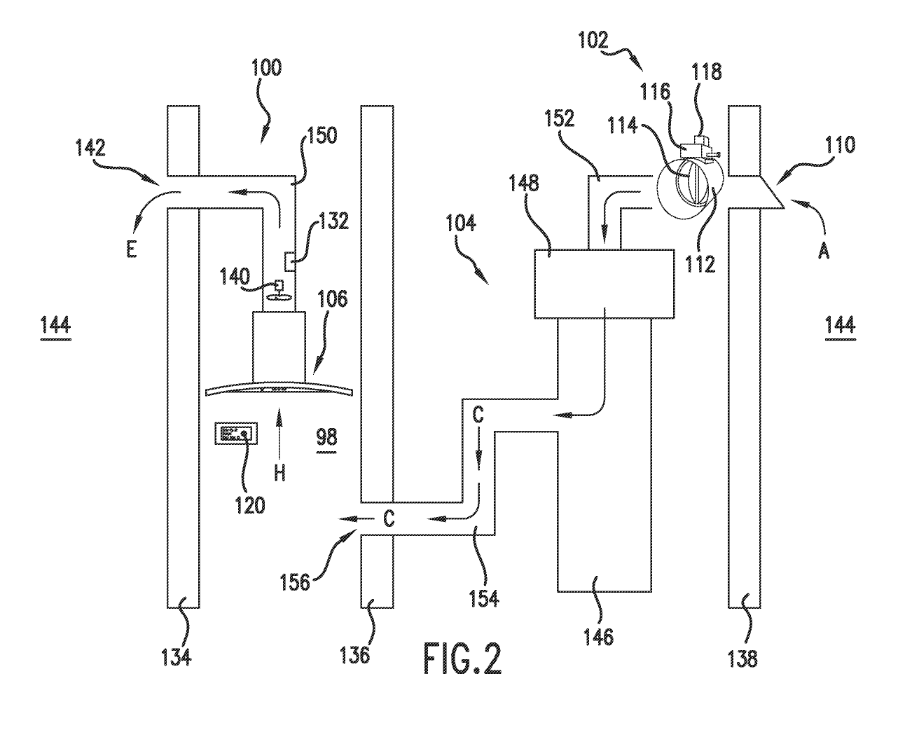

FIG. 1 provides a front view of an exemplary range hood 106 installed over an exemplary cook-top appliance 124 as may be used with the present invention. Range hood 106 is positioned directly over cook-top appliance 124, which is installed onto cabinetry 128. During operation of cook-top appliance 124, heat is provided by heating elements 126 to cook food items. In turn, the food items may generate smoke or fumes. Range hood 106 includes an air inlet 108 for the intake of air (arrows H) that may include heat and/or fumes for removal from kitchen 98. Range hood 106 includes a panel 158 having one or more controls 160 that can be used to activate lighting (not shown), activate a fan 140 (FIG. 2), and/or control other features.

The shape and configuration of the range hood 106 and cook-top appliance 124 shown in FIG. 1 are provided by way of example only. Other shapes and configurations may be used as well. The range hood may also be positioned near one or more cooking appliances without necessarily being located directly over each. Also, although a cook-top appliance is shown, the present invention may be used with other cooking appliances as well including ranges, ovens, microwaves, and other appliances that may produce heat and/or cooking fumes that need to be vented from a kitchen.

Kitchen 98 also includes a notification device 120 that is placed on wall 130. As will be further described, notification device 120 provides a notification to a user regarding whether a damper is operating properly. Notification device 120 may be provided in a variety of different forms. For example, notification device 120 may be one more lights, such as light emitting diodes (LEDs), that provide a visible notification. Different colors, such as e.g., red and green, may be used to indicate different conditions. Alternatively, notification device 120 may provide an audible notification such as an alarm or buzzer. In still another exemplary embodiment, notification device 120 may include a combination of a visible notification and an audible notification. Although shown in kitchen 98, notification device 120 could also be placed in other rooms or locations outside of kitchen 98 as well. Also, notification device 120 could also be placed on locations other than a wall such as e.g., a countertop, another appliance, or others.

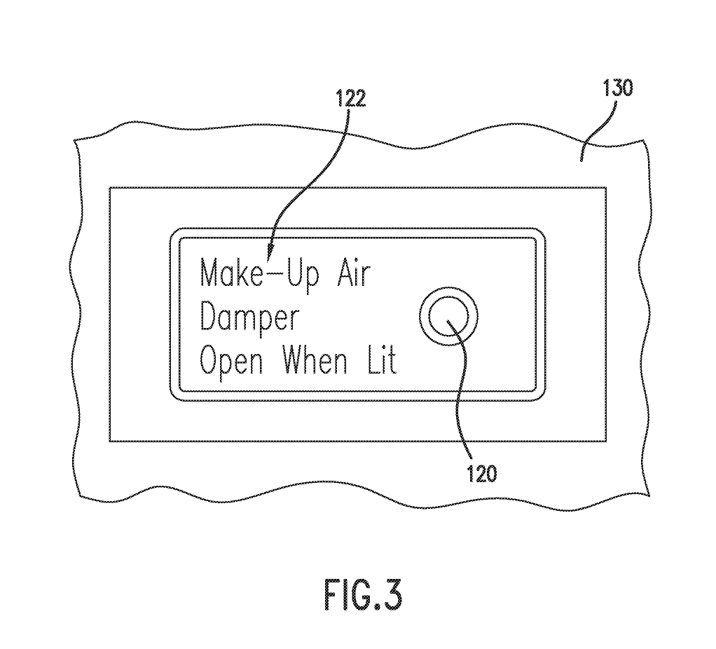

Notification device 120 can also be provided with various identifying indicia 122 as shown in close-up in FIG. 3. Indicia 122 in FIG. 3 provide an identification or explanation of notification device 120 as “Make-Up Air Damper Open When Lit.” Other indicia with different messages or wordings may be provided as well.

FIG. 2 provides a schematic view that includes a portion of kitchen 98 along with range hood 106 and will be used to further describe an exemplary embodiment of a system for damper activation notification. As shown, for an exemplary building where the present invention can be utilized, one or more exterior walls 134 and 136 separate the kitchen 98 from the outside—including the outside atmosphere—which is referred to herein as “ambient.”

A ventilation system 100 is provided that is configured to exhaust air from kitchen 98 to a location exterior of the kitchen such as e.g., ambient 144. For this exemplary embodiment, ventilation system 100 includes a duct 150 that connects range hood 106 with ambient 144. More particularly, the activation of fan 140 using one or more controls 160 causes air H (which may include heat energy and/or cooking fumes) to be drawn into air inlet 108, into exhaust duct 150, and exhausted to the ambient (arrows E) through exhaust outlet 142 in exterior wall 134. Controls 160 may also be used to e.g., control the speed of fan 140 and, therefore, the flow rate of air through exhaust duct 150. Although shown venting through exterior wall 134, it will be understood that venting could also occur through the roof and/or other structures as well.

As previously stated, in order for ventilation system 100 to function properly, kitchen 98 may need make-up air when fan 140 is activated so that the proper amount of air flow may be created through kitchen 98 to remove excess heat and/or cooking fumes when kitchen 98 is in use. Without a supply of make-up air, fan 140 may be otherwise unable to generate the proper air flow. In particular, there may not be enough air flow available to replace the air that should be drawn out of kitchen 98 when fan 140 is operating. In such situation, excessive heat and/or cooking fumes may stagnate in kitchen 98—depleting the efficacy of ventilation system 100. As used herein, make-up air refers to air drawn into kitchen 98 to replace the air in kitchen 98 that may be heated and/or contain cooking fumes from operation of kitchen 98.

Accordingly, make-up air system 102 is configured for providing air into kitchen 98 from ambient 144. For this exemplary embodiment, make-up air system 102 includes an ambient air inlet 110 in exterior wall 138 whereby ambient air (arrow A) is drawn through inlet 110 into make-up air duct 152. A damper 112 is positioned downstream of ambient air inlet 110 and within the make-up air duct 152. Damper 112 includes a valve 114 and may be positioned between i) an open position in which air can flow into the make-up air system from ambient 144 and ii) a closed position where air from the ambient is blocked from flowing through the make-up air system 102 from ambient 144. A damper motor 116 is provided for operation of valve 114. The construction of damper 112 as just described is provided by way of example—other constructions for controlling the inflow of air from ambient 144 may be used as well.

Make-up air system 102 also includes a damper sensor 118 that may be used to determine whether damper 112 is in the open position or the closed position. For example, damper sensor 118 may include e.g., a normally open switch that detects the position of valve 114 by assuming a closed position when valve 114 is in an open position allowing the flow of air through make-up air duct 152. Other configurations for damper sensor 118 may be used as well whereby the condition of damper 112 between an open position or a closed position may be determined

For this exemplary embodiment, make-up air system 102 is joined with an air conditioning system 104 for kitchen 98 that may provide heating, cooling, or both to kitchen 98. As shown, make-up air duct 152 is joined into the return 148 of heating/cooling unit 146. In turn, air is fed from heating/cooling unit 146 by air conditioning duct 154 to one or more supply vents 156 in wall 136 so as to provide conditioned air (arrows C) into kitchen 98. Thus, for this exemplary embodiment of the invention, make-up air (arrows A) provided by make-up air system 102 is heated or cooled (depending upon e.g., ambient temperature and the air temperature desired for kitchen 98) and then supplied to kitchen 98 (arrows C). Alternatively, make-up air from system 102 could be provided directly into kitchen 98 without conditioning as well.

In one exemplary method of providing a notification to the user of damper activation, a user may cause kitchen ventilation system 100 to operate or turn on by manipulating one or more controls 160. As such, fan 140 is activated so as to draw air through kitchen 98 for exhaust to ambient 144 along with heat energy and/or cooking fumes therein.

Next, damper sensor 118 is used to detect whether damper 112 is in an open position. In one exemplary aspect of the invention, damper sensor 118 may be used to continuously signal notification device 120. For example, when damper 112 is in an open position, damper sensor 118 may provide a signal (e.g., a voltage or the absence thereof) that causes notification device 120 to signal the user that damper 112 is open. When damper 112 is in a closed position, damper sensor 118 may provide a signal that causes notification device 120 to signal the user that damper 112 is closed. Such signals of an open or closed position can be provided continuously regardless of whether ventilation system 100 is activated.

In another exemplary aspect of the invention, ventilation system 100 includes an air flow sensor 132 positioned downstream of inlet 108. When the user activates range hood 106, air flow sensor 132 determines if air is flowing through ventilation system 100 from kitchen 98. If so, air flow sensor 132 provides a signal to activate damper 112 and cause it to move into an open position. In turn, damper sensor 118 provides a signal that indicates to notification device 120 whether damper 112 is in an open position or a closed position. Notification device 120 can then provide the appropriate notification to the user. Such notification can be provided regardless of whether air flow sensor 132 has provided a signal to damper 112.

The transmission of signals between air flow sensor 132 and damper sensor 118, and damper sensor 118 and notification device 120 can be provided in different forms. For example, these devices can be connected through electrical wiring for the transmission of one or more signals. Alternatively, or in combination therewith, wireless communications may be provided as well. Other exemplary methods of operation may also be used.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for providing notification of damper activation, comprising:
a ventilation system for providing an air exhaust from a kitchen to a location exterior of the kitchen, the ventilation system having an air inlet for the receipt of air from the kitchen;
a make-up air system configured for providing air into the kitchen from ambient, the make-up air system comprising
an ambient air inlet for the flow of air into the make-up air system from the ambient;
a damper positioned downstream of the ambient air inlet, the damper configured for movement between an open position where air can flow into the make-up air system from the ambient and a closed position where air from the ambient is blocked from flowing through the make-up air system;
a damper sensor configured for detecting whether the damper is in an open position; and
a notification device for viewing by a user, the notification device configured for providing a notification to the user based on the damper sensor detecting the damper changing between the closed position and the open position.

2. A system for providing notification of damper activation as in claim 1, further comprising:
an air flow sensor positioned in the ventilation system downstream of the air inlet, the air flow sensor configured for detecting whether air is flowing through the ventilation system from the air inlet.

3. A system for providing notification of damper activation as in claim 2, wherein the damper is configured to move into the open position when the air flow sensor detects air flowing through the ventilation system from the air inlet.

4. A system for providing notification of damper activation as in claim 3, wherein the air flow sensor is configured to provide a signal to the damper when the air flow sensor detects air flowing through the ventilation system from the air inlet.

5. A system for providing notification of damper activation as in claim 3, wherein the damper further comprises a damper motor configured for moving the damper between the open position and the closed position, wherein the air flow sensor is configured to provide a signal to activate the damper motor when the air flow sensor detects air flowing through the ventilation system from the air inlet.

6. A system for providing notification of damper activation as in claim 1, wherein the ventilation further comprises a hood defining the air inlet.

7. A system for providing notification of damper activation as in claim 6, wherein the notification device is integrated into the hood.

8. A system for providing notification of damper activation as in claim 1, wherein the notification device provides a visible notification, audible notification, or both.

9. A system for providing notification of damper activation as in claim 1, wherein the make-up air system is connected into an air conditioning system.

10. A system for providing notification of damper activation as in claim 1, wherein the damper sensor comprises a normally open switch positioned at the damper and configured to detect the position of the damper.

11. A method of providing notification of damper operation with a kitchen ventilation system and a make-up air system, the make-up air system comprising a damper for controlling a flow of air from ambient into the kitchen, the damper having an open position for allowing the flow of air from ambient and a closed position for blocking the flow of air from ambient, the method comprising the steps of:
operating the kitchen ventilation system so as to move air through the kitchen to remove heat, cooking fumes, or both;
detecting whether the damper is in the open position; and
providing a notification for a user of the kitchen regarding whether the damper is in the open position.

12. A method of providing notification of damper operation as in claim 11, further comprising the step of sensing whether air is flowing through the ventilation system from the kitchen.

13. A method of providing notification of damper operation as in claim 12, further comprising the step of activating the damper if air is flowing through the ventilation system.

14. A method of providing notification of damper operation as in claim 11, wherein said providing step comprises providing a visible signal, audible signal, or both, for the user of the kitchen.

15. A method of providing notification of damper operation as in claim 11, further comprising the step of causing air to flow into the make-up air system from ambient, into an air conditioning system for the kitchen, and into the ventilation system.

16. A method of providing notification of damper operation as in claim 11, further comprising the step of deactivating the ventilation system if the damper is in a closed position.
